(19) United States
(12) Patent Application Publication
(10) Pub. No.: US 2018/0258335 A1
(43) Pub. Date: Sep. 13, 2018

(54) ENVIRONMENTALLY FRIENDLY, NON-CLAY, AQUEOUS-BASED, BORATE CROSS-LINKER SLURRIES USING BORON-CONTAINING MINERALS

(71) Applicant: RadixKhem LLC, Missouri City, TX (US)

(72) Inventor: Manjit S. Chowdhary, Missouri City, TX (US)

(73) Assignee: RadixKhem LLC, Missouri City, TX (US)

(21) Appl. No.: 15/976,148

(22) Filed: May 10, 2018

Related U.S. Application Data
(63) Continuation of application No. PCT/US2016/061869, filed on Nov. 14, 2016.
(60) Provisional application No. 62/255,015, filed on Nov. 13, 2015.

(51) Int. Cl. C09K 8/03; C09K 8/88; C09K 8/90

(52) U.S. Cl. CPC C09K 8/03; C09K 8/90; C09K 8/887; C09K 8/885

(57) ABSTRACT

Methods and compositions regarding borate, cross-linking suspensions are disclosed that may include one or more non-clay suspending agents, at least 30 wt. % of one or more boron-containing minerals, and a water-based solvent. In additional embodiments, the suspensions may include one or more polyols, one or more additives, or both, wherein the additives, for example, may include stabilizing agents, dispersing agents, surfactants, wetting agents, anti-gelling agents, pour-point depressants, or combinations thereof. Turning to a different aspect of this disclosure are methods that may include mixing one or more non-clay suspending agents in a water-based solvent and adding, subsequent to this mixing, at least 30 wt. % of one or more boron-containing minerals. In other embodiments, example methods may also include adding one or more additives prior to adding at least 30 wt. % of one or more boron-containing minerals.

### CROSS-REFERENCE TO RELATED APPLICATION

The present application is a continuation application, which claims priority to Patent Cooperation Treaty (PCT) application PCT/US16/61869 filed on Nov. 14, 2016, which claims priority to the U.S. provisional patent application Ser. No. 62/255,015 filed on Nov. 13, 2015, wherein both of these priority applications are incorporated in their entireties and were titled the same as this application.

### FIELD OF DISCLOSURE

This disclosure generally pertains to methods, slurries, kits and compositions for creating environmentally friendly, non-clay, aqueous-based suspensions of boron-containing minerals and their mixtures.

### BACKGROUND

A suspension may be described as a heterogeneous mixture having solids dispersed throughout the dispersed phase, i.e., often solid, suspended in a dispersion medium, e.g., solids, liquids and/or gases. Suspended particles in the suspension will settle over time if left undisturbed, and, thus, dispersion and thermal stability are important properties of a suspension. The suspension, itself, may be formed by mixing, whether manually, via highs-speed mixing, or otherwise agitating in order to form a slurry.

Oftentimes, suspending agents are used to assist in suspension formation. A suspending agent may be defined as an amorphous and/or fibrous material that is used to impart viscosity and suspension properties to a mixture, such as a suspension that has an oil-based carrier like an oil-based drilling fluid suspension. The suspending agent promotes stable suspensions and increased suspension of solids in the dispersion medium. Promotion of at least stability and increased, suspended solids that are functional, as opposed to objectionable, provide improved drilling fluids for use, for example, in preventing formation damage. Furthermore, such improved drilling fluids cost less because suspending agents are not required.

### SUMMARY

In one embodiment, there is disclosed a suspension that may include one or more non-clay suspending agents, at least 30 wt. % of one or more boron-containing minerals, and a water-based solvent. In additional example embodiments, the suspension may include one or more polyols, one or more additives, or both, wherein the additives, for example, may include stabilizing agents, dispersing agents, surfactants, wetting agents, anti-gelling agents, pour-point depressants, or combinations thereof.

In another embodiment, disclosed is a method for suspending a borate solution. The method may include mixing one or more non-clay suspending agents in a water-based solvent and adding, subsequent to this mixing, at least 30 wt. % of one or more boron-containing minerals. In other embodiments, example methods may also include adding one or more additives prior to adding at least 30 wt. % of one or more boron-containing minerals.

### BRIEF DESCRIPTION OF THE DRAWINGS

So that the manner in which the recited features, advantages and objects of this disclosure are attained and may be understood in detail, a more particular description, briefly summarized above, may be had by reference to the embodiments thereof which are illustrated in the appended drawings.

It is to be noted, however, that the appended drawings illustrate only example embodiments and/or properties of the composition and methods provided in of this disclosure, and are, therefore, not to be considered limiting of its scope, for the disclosure may admit to other equally effective embodiments supported by the text of this description and/or ordinary skill possessed in the art.

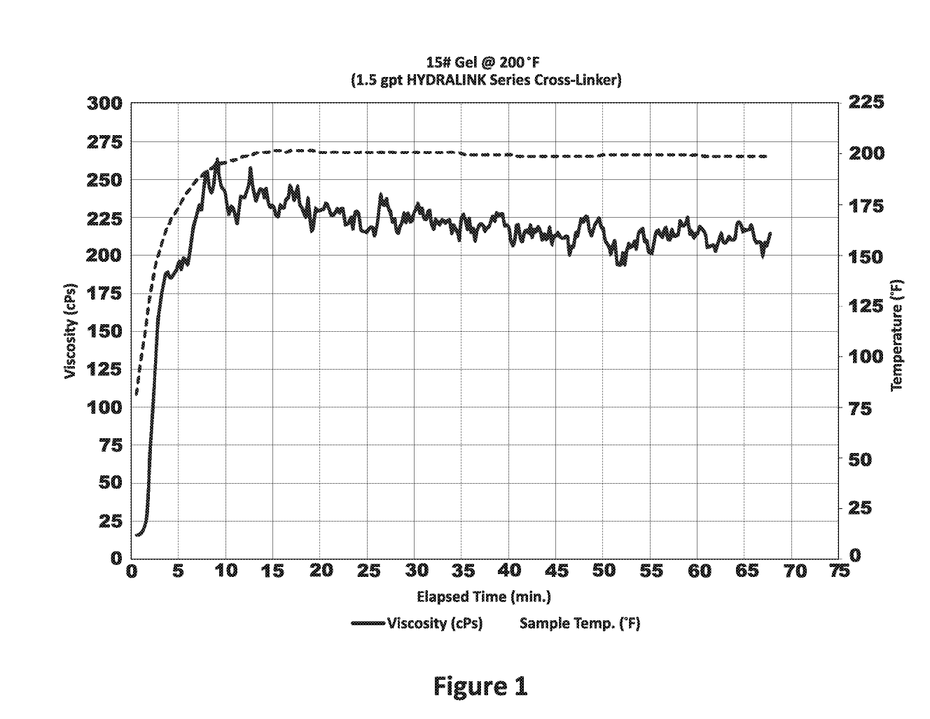

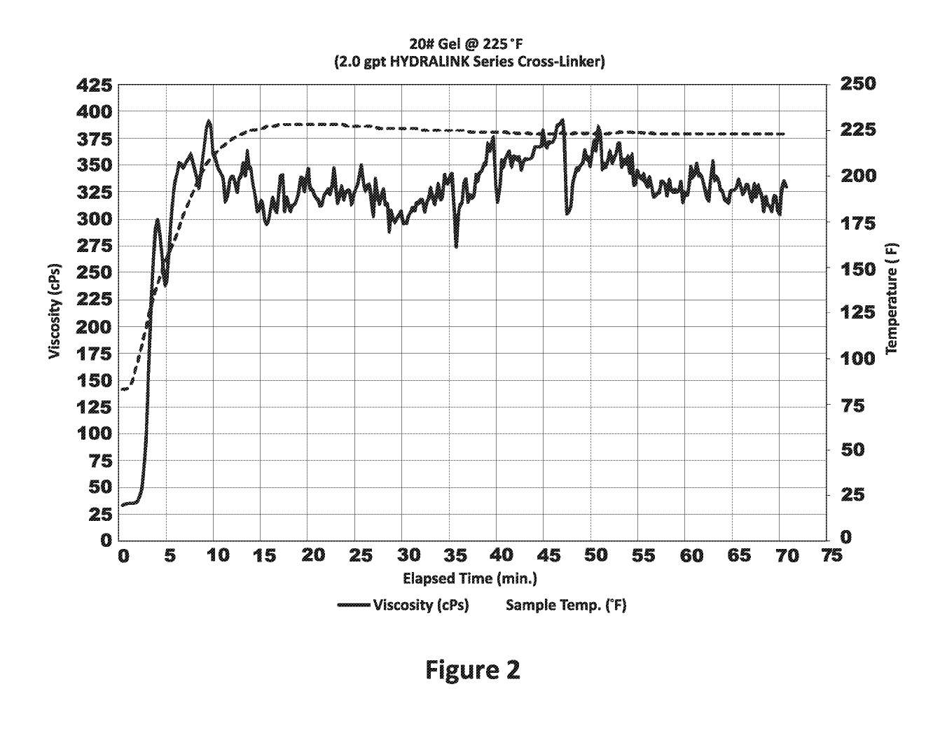

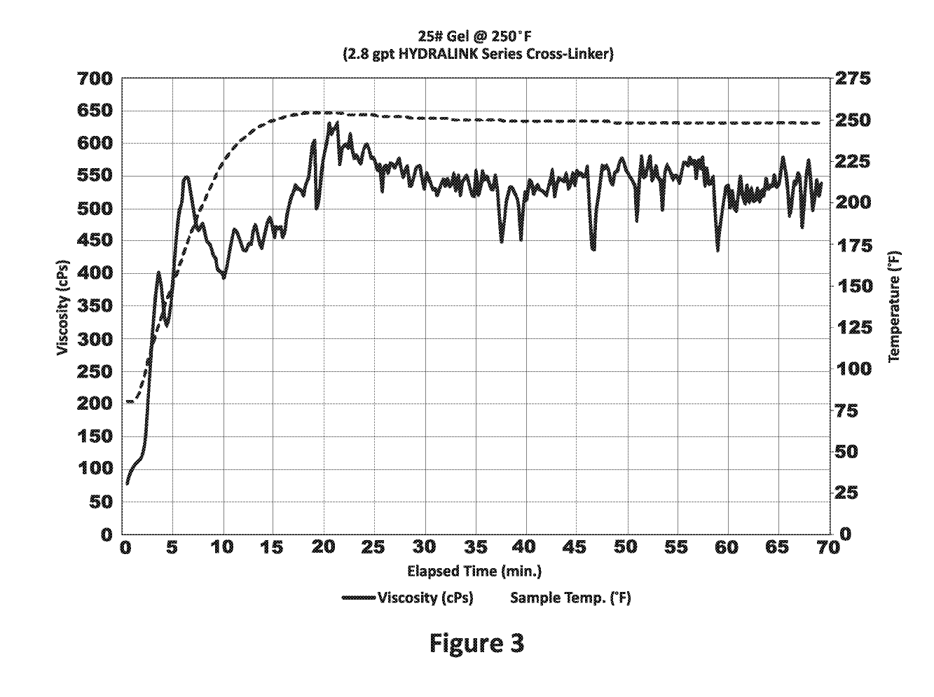

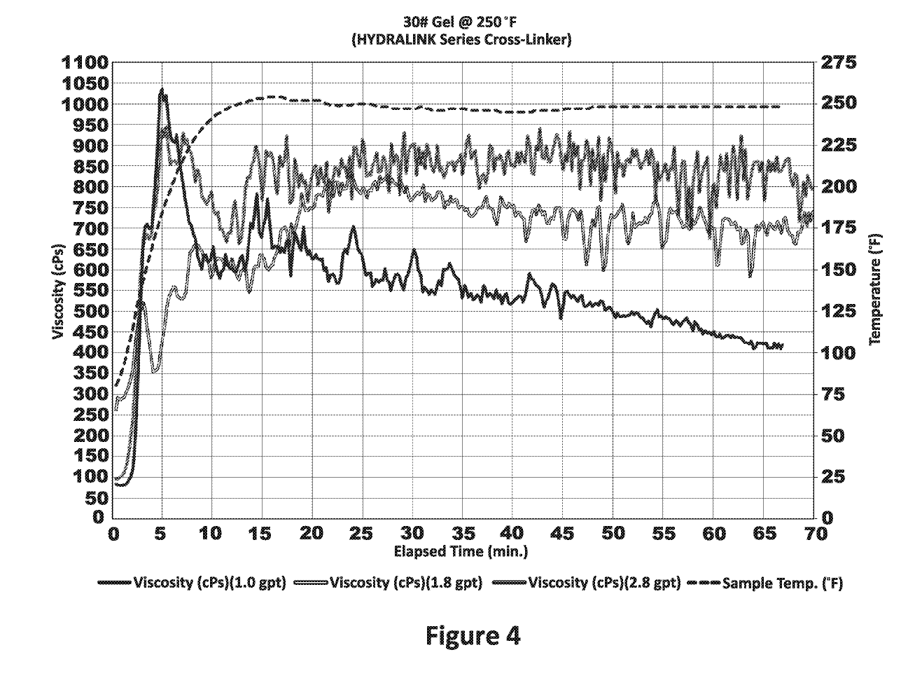

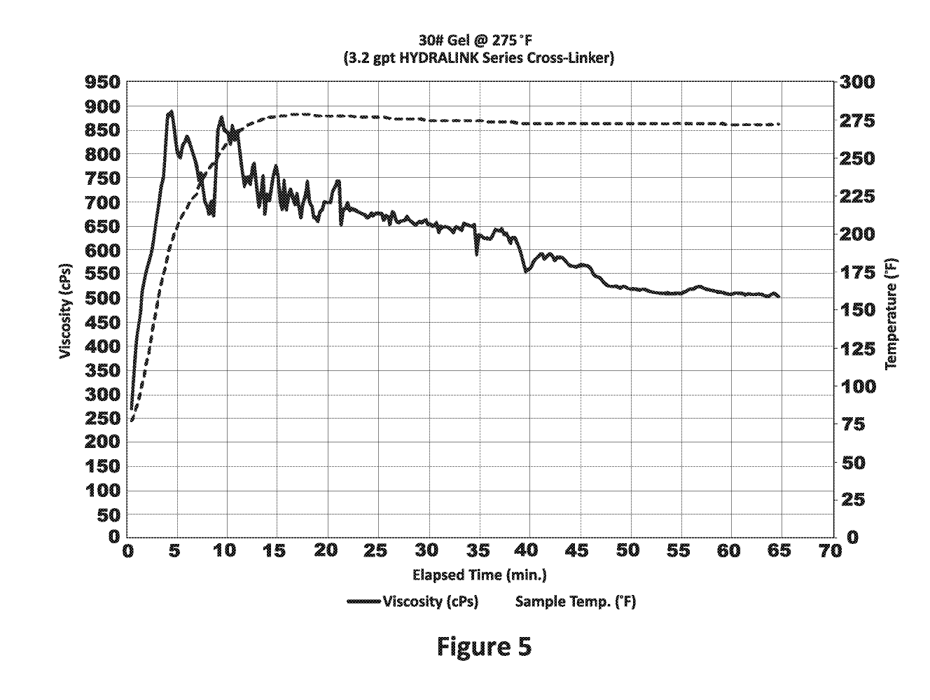

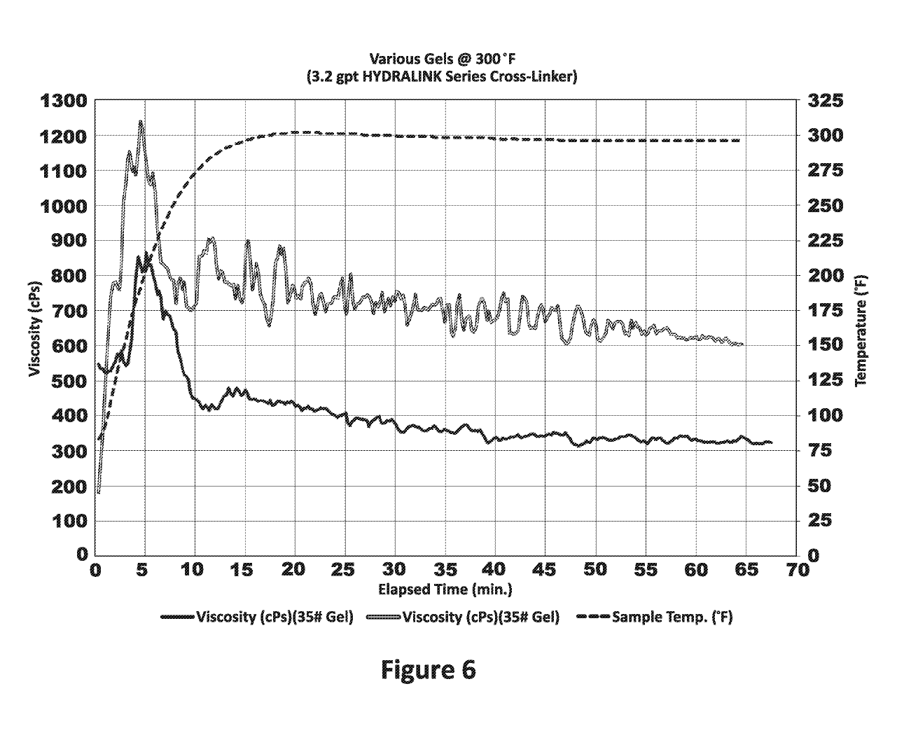

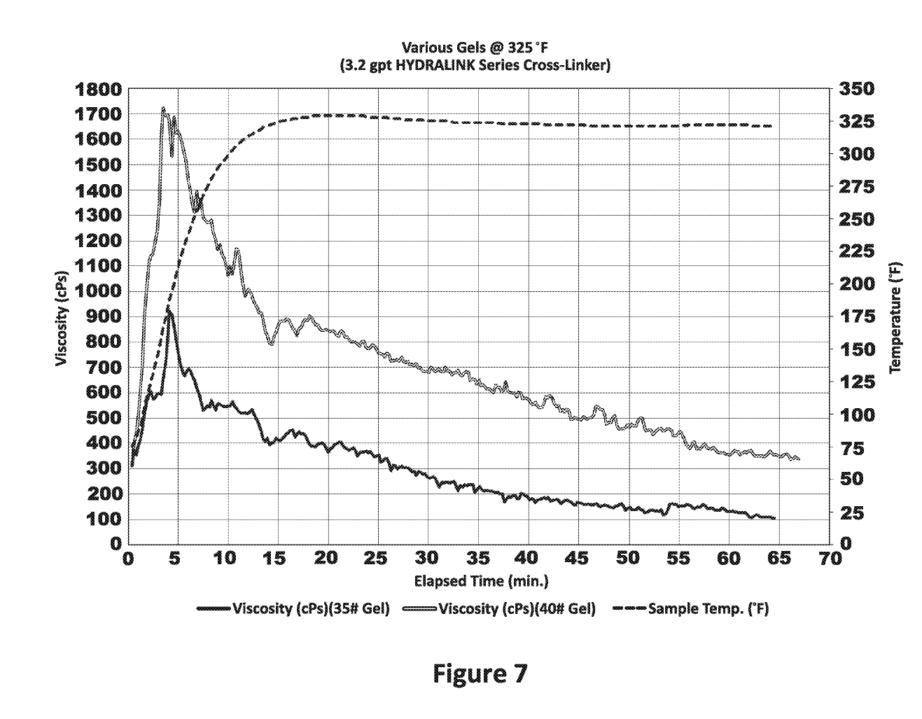

As shown thereon, FIGS. 1-7 depict graphical representations of example embodiments of stable, gelatinous, water-based suspensions having boron-containing minerals in grams per ton (“gpt”), denominated therein as HYDRALINK, over a temperature range from about 90° C. (i.e., 200° F.) to about 163° C. (i.e., 325° F.) with varying viscosities in centipoises (“cP”) over a period of approximately 70 minutes.

### DETAILED DESCRIPTION

This disclosure relates to methods, slurries, kits and/or pre-packed materials for creating environmentally friendly, non-clay, aqueous-based suspensions of boron-containing minerals and their mixtures, which may be used, e.g., with or as downhole treatment fluids, at temperatures ranging from 60° C. and lower to 175° C. and higher, whereas current borate products typically work from approximately 50-150° C. Stated otherwise, the disclosed suspensions may be stable and usable at temperatures below 50° C., and/or may be stable and useable at temperatures above 150° C., from above 150° C. to 175° C., and above 175° C. The disclosed suspensions may include water-soluble, reactive solids, e.g., sparingly soluble alkaline metal borate ions, which can produce momentarily or longer delayed, i.e., fraction of a second, second(s), or longer, borate cross-linking in aqueous, non-oily, and/or polyol-based solvents, and optionally include one or more additives. As this suspension provides cross-linking in polysaccharide-based, e.g., guar, guar derivatives and other polysaccharides, systems, high-viscosity gels may be formed during downhole travel; delay times may range, for example, from second(s) to several minutes and more. The delay time may be altered through the use of delaying agents like sodium gluconate, polyols and/or alcohols like mannitol, sorbitol and others, as well as through pH adjusters. Consequently, the energy required for pumping may be reduced substantially. These suspensions are stable for weeks at temperatures ranging from −15° C. to 55° C. Additionally, pour points range from approximately −15° C. to −20° C. and lower, and Brookfield viscosities, as measured with model RVDV (DV2T), range from approximately 500 cPs to 3,500 cPs at 25° C.

The use of borate cross-linking, including both instant and delayed types, is well known in hydraulic fracturing. Instant borate cross-linkers are used primarily for lower temperature wells or in conjunction with delayed borate cross-linkers in higher temperature wells, whereas current delayed borate cross-linkers are routinely used at higher temperatures, e.g., in excess of 90° C. though these cross-linkers are commonly used at lower temperatures as well. Borate-based cross-linking is reversible; at pH of about 8 or more, the gel cross-links, and at pH of about 5 or below, the cross-linking falls apart. This type of cross-linking involves coordinated bond formation, which can be broken by bringing the pH to about 5 or lower. Generally, instant borate cross-linkers are available in a concentrated solution in organic solvents, and delayed borate cross-linkers are available in mineral oil-based or aqueous-based slurries.

A number of boron-containing minerals, i.e., alkaline earth metal borates or alkali metal alkaline earth metal borates as described below, are available for making slurries, including, for example: meyerhofferite, gowerite, inyoite, frolovite, colemanite, ginorite, inderborite, maliborite, nobleite, kurnakovite, kaliborite, precobrazhenskite, pinnoite, priceite, probertite, ginorite, ulexite, veatchite, tertschite, others, and combinations thereof.

Typically, these boron-containing minerals are suspended in mineral oils, and the suspending agents, e.g., organophilic clays, used in the suspensions are well known in the art of making slurries. These slurries provide borate ions necessary for cross-linking water-soluble polymers, e.g., guar gum, cellulose and other high molecular weight polysaccharides that thicken gels and can suspend proppants for fracturing, as well as their respective derivatives, including, for example and without limitation, hydroxyl propyl guar, carboxy methyl guar, carboxy methyl hydroxypropyl guar, hydroxy propyl cellulose, carboxy methyl hydroxyl propyl cellulose and hydroxy ethyl cellulose, others, and combinations thereof.

Similarly, delayed borate cross-linking has been known by using encapsulated boron ions at 150° C., which has been described in Nelson, Erik B., et al. in U.S. Pat. No. 5,658,861A.

Currently, the boron-containing mineral of choice in the art has been ulexite. Noteworthy is that the same or similar boron-containing minerals may be associated with one or more names. For instance, ulexite may also be referred to as hydrated sodium calcium borate hydroxide.

The sparingly soluble boron-containing minerals used in the disclosed suspensions (e.g., ulexite) are sourced. The CAS number for ulexite is 1319-33-9. The chemical formulas for this mineral are:

### Ulexite

NaCaB₅O₆(OH)₆.5H₂O or Na₂O.2CaO.5B₂O₃.16H₂O

Ulexite is commercially available in two grinds, namely standard (i.e., 200 mesh) and fine (i.e., 325 mesh).

Various suspending agents useful for suspension of boron-containing minerals are discussed in U.S. Pat. Nos. 6,936,575 and 5,629,272. The present suspension utilizes none of these agents for suspension of the boron-containing minerals.

Various polysaccharides in combination with certain polyols are examples of the suspending agents used in the disclosed suspensions. Additional components to the disclosed suspensions include stabilizing agents that stabilize the suspensions at various temperatures (including at both room and higher temperatures), dispersing agents to disperse the boron-containing minerals uniformly, surfactants and wetting agents, which improve the smoothness of slurry flow and process ability, anti-gelling agents, and pour point depressants that lower the pour point of the slurry.

The boron-containing mineral concentration in the disclosed suspensions may be up to 70% by weight or in lesser amounts, including, for example, from 30% through 70% by weight, from 35% through 70% by weight, from 40% through 70% by weight, from 45% through 70% by weight, from 50% through 70% by weight, from 55% through 70% by weight, from 60% through 70% by weight, or from 65% through 70% by weight.

Rather than formulating a concentrated solution of a boron-containing mineral in water and then treating with one or more additives, the method involved in this disclosure is to formulate an aqueous, non-oily or polyol-based solution with one or more additives, and then add the boron-containing mineral(s).

The following example will illustrate the preparation and the properties of example embodiments, but should not limit the scope of the invention, unless otherwise indicated in the claims. All percentages, concentrations, ratios, parts, etc. are by weight unless otherwise noted or apparent from their use.

### EXAMPLES

An environmentally friendly, water-based, borate suspension was prepared in two steps.

First, distilled water was mixed with an appropriate polysaccharide and mixed for 15 minutes. After preparing this aqueous-based solution, a variety of different formulations may be made, for example, with any polyols or polymers thereof. Once this solution is prepared and mixed well, the final step of adding one or more boron-containing minerals occurs, wherein the suspension is mixed for an additional 30 minutes to obtain an easily flowable, thin slurry.

In one example embodiment, a suspension was prepared by first adding a polysaccharide, i.e., natural or synthetic, to either tap water from Houston, Tex. or distilled water in order to provide suspending properties to the water to result in a 0.01-0.80 wt % solution. While mixing on an overhead blender or Hamilton Beach® blender, certain polyols at 2.00-20.00 wt % were added. After approximately 2 minutes, a dispersant and/or stabilizer at 0.010-10.00 wt % were added, and mixing continued for another 2 minutes. A wetting agent at 0.01-3.00 wt % was added and mixed for another 2 minutes. Then a pour point depressant was added at 0.50-10.00 wt % and mixed for 10 minutes. Finally, boron-containing mineral(s), including mixtures thereof, were added at 30-70 wt. % and the solution was mixed one last time for 30 minutes.

By altering the foregoing percentages, as well as the mixtures of the boron-containing minerals, one can customize the properties of the disclosed suspensions.

Suspensions made by the foregoing process are stable with no separation over several days and weeks, including at various temperatures, e.g., at low temperatures such as −15° C. and at high temperatures such as 55° C., and upon freeze/thaw conditions, i.e., once frozen, and then upon heating, the suspension will revert to a suspended state that is a uniformly dispersed without any agitation required. Cross-linking delay times can be manipulated from second(s) to a few minutes by the addition of additives known in the art.

Cross-link tests with the appropriate polysaccharide polymer at various temperatures are simulated on FANN-50 or similar instruments.

The foregoing suspensions may be tested by methods known in the art. Such tests are disclosed in various patents, some of which are those that are mentioned herein. Such tests include measuring vortex closure, crown and lip times, as well as stability tests under pressure and temperature on a FANN 50 or similar instrument.

While the foregoing is directed to example embodiments of the disclosed invention, other and further embodiments may be devised without departing from the basic scope thereof, wherein the scope of the disclosed applications, compositions, structures, labels, and so forth are determined by one or more claims of at least one subsequently filed, non-provisional patent application.

What is claimed is:

1. A suspension comprising:
one or more non-clay suspending agents;
at least 30 wt. % of one or more boron-containing minerals; and
a water-based solvent.

2. The suspension of claim 1, further comprising one or more polyols.

3. The suspension of claim 1, wherein the one or more non-clay suspending agents comprise one or more polysaccharides.

4. The suspension of claim 1, wherein the water-based solvent is non-oily.

5. The suspension of claim 1, further comprising one or more additives.

6. The suspension of claim 4, wherein the one or more additives comprise stabilizing agents, dispersing agents, surfactants, wetting agents, anti-gelling agents, pour-point depressants, or combinations thereof.

7. The suspension of claim 1, wherein the one or more boron-containing minerals comprise meyerhofferite, gowerite, inyoite, frolovite, colemanite, ginorite, inderborite, maliborite, nobleite, kurnakovite, kaliborite, precobrazhenskite, pinnoite, priceite, probertite, ginorite, ulexite, veatchite, tertschite, other boron-containing minerals, or combinations thereof.

8. The suspension of claim 1, wherein the suspension produces borate cross-linking that occurs in a fraction of a second, seconds, a minute, or several minutes.

9. The suspension of claim 1, wherein the suspension is stable for weeks at temperatures within a range from −15° C. through 55° C.

10. The suspension of claim 1, wherein the suspension has a pour point of −15° C. or lower.

11. The suspension of claim 1, wherein the suspension has a viscosity within a range from 500 cPs through 3,500 cPs at 25° C.

12. The suspension of claim 1, wherein the one or more boron-containing minerals comprises from 30 wt. % through 70 wt. %.

13. The suspension of claim 1, wherein the suspension reverts to a suspended state without requiring agitation upon thawing the suspension from a frozen state.

14. The suspension of claim 1, wherein the suspension is stable and usable at temperatures below 50° C.

15. The suspension of claim 1, wherein the suspension is stable and usable at temperatures above 150° C.

16. The suspension of claim 1, wherein the suspension is stable and usable at temperatures from with a range from 150° C. through 175′C.

17. A method for suspending a borate solution, the method comprising:
mixing one or more non-clay suspending agents in a water-based solvent; and
adding, subsequent to the mixing, at least 30 wt. % of one or more boron-containing minerals.

18. The method of claim 17, further comprising adding one or more additives prior to the adding at least 30 wt. % of one or more boron-containing minerals.

19. The method of claim 17, wherein the mixing further comprises adding one or more polyols.

20. The method of claim 17, wherein the at least 30 wt. % comprises from 30 wt. % through 70 wt. %.
